(19) United States
(12) Patent Application Publication
(10) Pub. No.: US 2010/0114562 A1
(43) Pub. Date: May 6, 2010

(54) DOCUMENT PROCESSOR AND ASSOCIATED METHOD

(75) Inventors: Ben Hutchinson, Chatswood (AU); Tanja Gaustad, Chatswood (AU); Dominique Estival, Chatswood (AU); Wil Radford, Chatswood (AU); Son Bao Pham, Chatrswood (AU)

Correspondence Address: GEORGE A LEONE, SR;CITADEL PATENT LAW, 9124 Gravelly Lake Drive SW, SUITE 102, Lakewood, WA, 98499, US

(73) Assignee: APPEN PTY LIMITED, Chatswood, New South Wales (AU)

(21) Appl. No.: 12/513,099

(22) PCT Filed: Apr. 5, 2007
(86) PCT No.: PCT/AU07/00441

§ 371 Date: Nov. 19, 2009

(30) Foreign Application Priority Data
Nov. 3, 2006 (AU) 2006906095
Nov. 28, 2006 (AU) 2006906623

(51) Int. Cl. G06F 17/27; G06F 15/18

(52) U.S. Cl. 704/9; 706/12

(57) ABSTRACT

A computer implemented method of processing a digitally encoded document having a text composed by an author by using a processor to analyse the segmentation, punctuation and linguistics of text and storing the results in a digitally accessible format. Author traits are then predicted using a machine learning system based on the results of the segmentation, punctuation and linguistics analysis of the text.

### STATEMENT RE U.S. GOVERNMENT RIGHTS

This invention was made with U.S. Government support under Contract No. W91CRB-06-C-0012 awarded by U.S. Army RDECOM ACQ CTR-W91CRB. The U.S. Government has certain rights in this invention.

### FIELD OF THE INVENTION

The present invention relates to a method and apparatus for processing documents. Embodiments of the present invention find application, though not exclusively, in the field of computational text processing, which is also known in some contexts as natural language processing, human language technology or computational linguistics. The outputs of some preferred embodiments of the invention may be used in a wide range of computing tasks such as automatic email categorization techniques, sentiment analysis, author attribution, and the like.

### BACKGROUND OF THE INVENTION

The use of text-based electronic communication means, such as email, SMS messaging, internet chat rooms, instant messaging, and the like, has become increasingly pervasive throughout the last decade and hence the data contained within those electronic text based communication formats may constitute a valuable source of information for some entities, particularly those that either receive or intercept a large volume of such communications. It has been appreciated by the inventors that it would be advantageous to provide sophisticated tools for extracting useful data from various forms of electronic communications.

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

### SUMMARY OF THE INVENTION

It is an object of the present invention to overcome, or substantially ameliorate, one or more of the disadvantages of the prior art, or to provide a useful alternative.

In accordance with a first aspect of the present invention there is provided a computer implemented method of processing a digitally encoded document having text composed by an author, said method including the steps of:

using a processor to analyse segmentation of the text and storing results of said segmentation analysis in a digitally accessible format;

using a processor to analyse punctuation of the text and storing results of said punctuation analysis in a digitally accessible format;

using a processor to linguistically analyse the text and storing results of said linguistic analysis in a digitally accessible format; and

predicting an author trait using a machine learning system that is adapted to receive the results of said linguistic analysis, said segmentation analysis and said punctuation analysis as input, said machine learning system having been trained to process said input so as to output at least one predicted author trait.

Preferably the linguistic analysis includes identification of predefined words and phrases in the text and the words and phrases may include any one or more of the following types: peoples' names, locations, dates, times, organizations, currency, uniform resource locators (URL's), email addresses, addresses, organizational descriptors, phone numbers, typical greetings and/or typical farewells. A preferred embodiment makes use of a database of words and phrases of these types.

Preferably the segmentation analysis includes an analysis of the paragraph and sentence segmentation used in the text.

Preferably the results of said linguistic analysis, said segmentation analysis and said punctuation analysis are represented by one or more data structures associated with the document. In a preferred embodiment the data structures are feature vectors.

In various preferred embodiments the machine learning system utilizes any one or more of the following techniques:

Support Vector Machines;

Naïve Bayes;

Decision Trees;

Lazy Learners;

Rule-based Learners;

Ensemble/meta-learners and/or

Maximum Entropy.

Preferably the machine learning system has been trained with reference to a representative sample of training documents and with reference to known author trait information associated with each of the training documents.

A preferred embodiment includes a step of processing the document to ascertain whether the document is in a preferred format and, if the document is not in the preferred format, converting at least some of the information within the document to the preferred format.

Preferably the document is, or includes, any one of: an email; text sourced from an email; data sourced from a digital source; text sourced from an online newsgroup discussion; text sourced from a multiuser online chat session; a digitized facsimile; an SMS message; text sourced from an instant messaging communication session; a scanned document; text sourced by means of optical character recognition; text sourced from a file attached to an email; text sourced from a digital file; a word processor created file; a text file; or text sourced from a web site.

Preferably the at least one predicted author trait is a demographic trait, such as age, gender, educational level, native language, country of origin and/or geographic region for example. Alternatively, or in addition, the at least one predicted author trait may be a psychometric trait, such as extraversion, agreeableness, conscientiousness, neuroticism, psychoticism and/or openness, for example.

Preferably the at least one predicted author trait is associated with a confidence level representing an estimate of the likelihood that the predicted trait is correct.

In a preferred embodiment the document is parsed so as to distinguish author composed text from non-author composed text and author composed text is primarily used as the basis for the prediction of author traits.

In accordance with a second aspect of the present invention there is provided a method of training a machine learning system, said method including:

compiling a representative sample of training documents, each training document being associated with known author trait information;

using a processor to linguistically analyse text of the training documents and storing the results of said linguistic analysis in a digitally accessible format;

using a processor to analyse segmentation of the text of the training documents and storing the results of said segmentation analysis in a digitally accessible format;

using a processor to analyse punctuation of the text of the training documents and storing the results of said punctuation analysis in a digitally accessible format; and

using the machine learning system in a training mode to process the results of said linguistic analysis, said segmentation analysis and said punctuation analysis, along with the associated known author trait information, so as to formulate a function for use by the machine learning system in an operational mode to process input documents so as to output at least one predicted author trait.

Preferably at least some of said known author trait information is compiled by subjecting known authors to a questionnaire. In a preferred embodiment the questionnaire includes questions adapted to elicit answers relating to demographic and/or psychometric traits of the known authors.

According to a third aspect of the invention there is provided a computer-readable medium containing computer executable code for instructing a computer to perform a method according to any one of the preceding claims.

According to a fourth aspect of the invention there is provided a downloadable or remotely executable file or combination of files containing computer executable code for instructing a computer to perform a method according to the first or second aspect of the invention.

According to a fifth aspect of the invention there is provided a computing apparatus having a central processing unit, associated memory and storage devices, and input and output devices, said apparatus being configured to perform a method according to the first or second aspect of the invention.

According to a sixth aspect of the invention there is provided a machine learning system for processing a digitally encoded document having text composed by an author, said machine learning system having been trained to process said document so as to output at least three of the following six predicted author traits:

age; gender; educational level; native language; country of origin and/or geographic region.

According to another aspect of the invention there is provided a machine learning system for processing a digitally encoded document having text composed by an author, said machine learning system having been trained to process said document so as to output at least three of the following six predicted author traits:

extraversion; agreeableness; conscientiousness; neuroticism; psychoticism and/or openness.

As used in this document, the terms “predict”, “predicted” and the like, should not necessarily be construed as relating to the forecasting of a possible future events or facts. Rather, in at least some contexts, the term “predict”, “predicted” and the like, should be construed in a manner akin to “infer”, “surmise” or “deduce”.

The features and advantages of the present invention will become further apparent from the following detailed description of preferred embodiments, provided by way of example only, together with the accompanying drawings.

### BRIEF DESCRIPTION OF THE ACCOMPANYING DRAWINGS

FIG. 1 is a schematic depiction of an embodiment of the invention in an operational mode;

FIG. 2 is a schematic depiction of an embodiment of the invention in a training mode;

FIG. 3 is a schematic depiction of a preferred embodiment of a computing apparatus according to the invention;

FIG. 4 is a depiction of an output screen provided by a preferred embodiment of the invention; and

FIGS. 5 to 16 respectively depict the ontologies of character based features, paragraph based features, line based features, multi-word based features, date based features, word based features, time based features, person based features, currency based features, lexicon based features, degenerate based features and HTML based features.

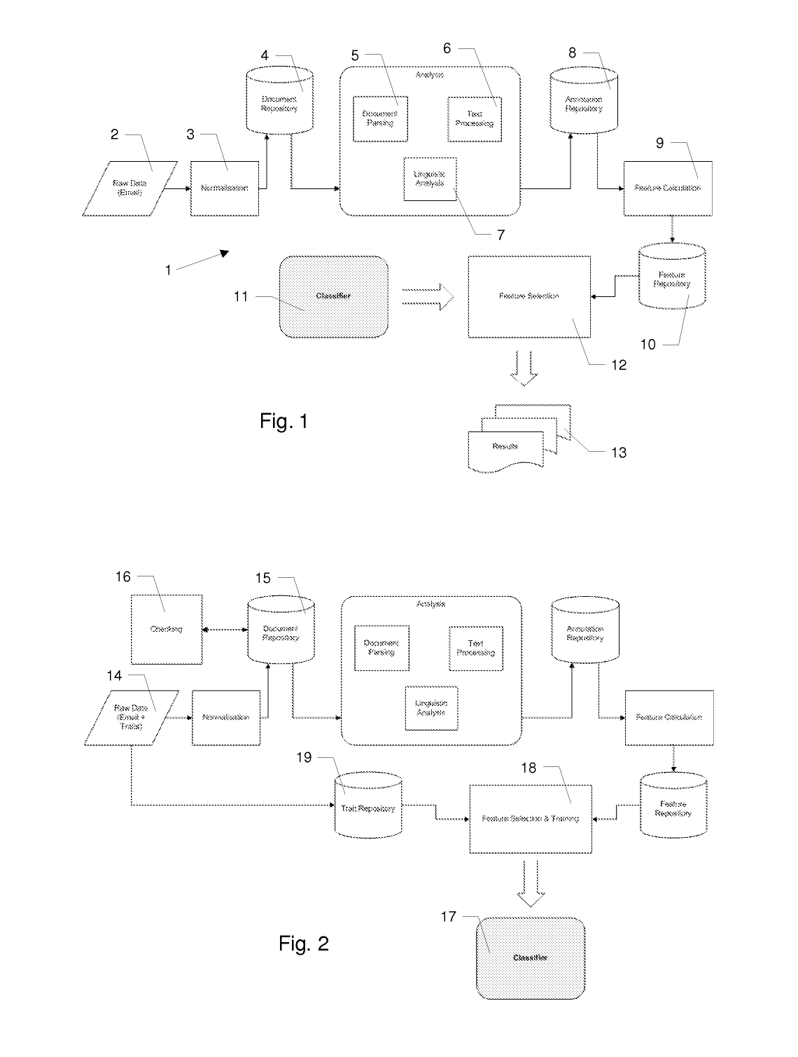

### DETAILED DESCRIPTION OF PREFERRED EMBODIMENTS OF THE INVENTION

With reference to the figures, the preferred embodiment of the invention carries out a computer implemented method 1 of processing digitally encoded documents. In the illustrated preferred embodiment the documents that are processed are emails 2. However in other preferred embodiments the documents that are processed include text copied or extracted from one or more other digital sources, such as: online newsgroup discussions; multiuser online chat sessions; digitized facsimiles; SMS messages; instant messaging communication sessions; scanned documents; text sourced by means of optical character recognition; any digital files including files attached to emails, word processor created files and text files; or text sourced from web sites, for example. The aim of the preferred embodiment is to predict a number of traits associated with the author of the document that is being processed.

It will be appreciated that the actual hardware platform upon which the invention is implemented will vary depending upon the amount of processing power required. In some embodiments the computing apparatus is a stand alone computer, whilst in other embodiments the computing apparatus is formed from a networked array of interconnected computers.

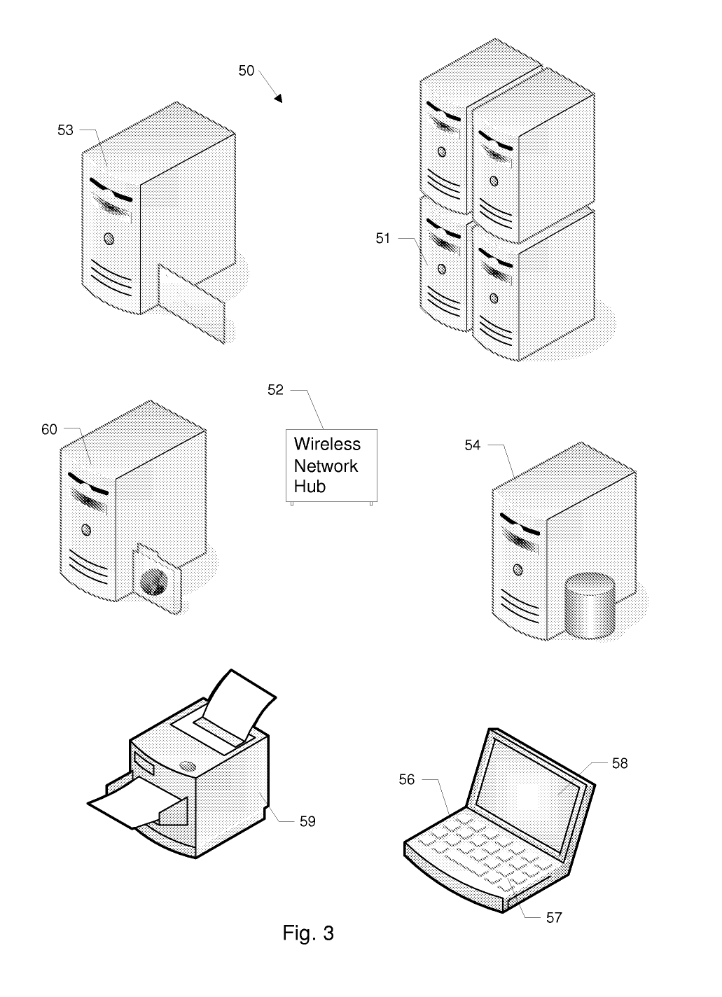

The preferred embodiment utilizes a computing apparatus 50 as shown in FIG. 3, which is configured to perform the document processing. This computing apparatus includes a computer 51 having a central processing unit (CPU); associated memory, in particular RAM and ROM; storage devices such as hard drives, writable CD ROMS and flash memory. The computer 51 is also communicatively connected via a wireless network hub 52 to an email server 53, a database server 54, an internet server 60 and a laptop computer 56, which functions as a user interface to the networked hardware. The laptop computer 56 provides the user with input devices such as a keyboard 57 and a mouse (not illustrated); and a display in the form of a screen 58. The laptop computer 56 is also communicatively connected via the wireless network hub 52 to an output device in the form of a printer 59. The email server 53 includes an external communications link in the form of a modem. Email messages 3 are received by the email server 55 and relayed via the wireless network hub 52 to the computer 51 for processing. Depending upon user requirements, a copy of the original document 3 may also be stored on the database server 54. When configured to process internet sourced documents, such as chat room or instant messaging conversations, for example, the preferred embodiment makes use of the internet server 60 to access the documents.

For the sake of a running example, the processing of the following exemplary email document shall be described:

```
-----Original Message-----
From: Commercial Services
Sent: Monday, May 08, 2006 3:23 PM
To: ‘jalexanderhal@hotmail.com’
Subject: RE: Special Request
Hi Joe Alexander,
Thank you for inquiring about our Bank Services program.
Thank you for
your recent Bank Services inquiry. The Frank & Miller Bank
Services
program can give you one-stop convenience for all of your
upkeep and
home improvement needs, including online change of address
and utilities
connections with Speed Banking. Here is the link to access
this
information: http://bankservices.frankmiller.com. The
vendors are listed
by category and their contact information is also available
on-line. In
order to receive quotes on the services you've requested,
it is advised
to directly contact that vendor as Bank Services does not
have access to
pricing information.
If you require any moving services, however, please feel
free to browse
our website for our movers' information and then call us at
888.572.9427
so that we can set up an appointment for an estimate.
If you have any questions, please don't hesitate to email
or call at
888.572.9427.
Best Regards,
The Bank Services Team
888.572.9427
bankservices@frankmiller.com
-----Original Message-----
From: jalexanderhal@hotmail.com
[mailto: jalexanderhal@hotmail.com]
Sent: Monday, May 08, 2006 3:13 PM
To: Bank Services
Subject: Special Request
Frank & Miller Bank Services - Special Request
Submitted
    Time: 5/8/2006 4:12:32 PM
Origins
    Origin: Our Site
    Origin 2:
Message from
    Name: Joe Alexander Hal
    E-mail: jalexanderhal@hotmail.com
    Phone: (507) 359-7891
    Additional Phone:
    Contact Method: phone
    Contact Time: Evening (5:00 pm-8:00 pm)
    Contact ASAP: Yes
Customer responses
    I'm interested in buying a house, and I would like:
        More information on your Bank Services program
Frank & Miller - Your Favorite Bank Services Provide Since
1875
```

The original versions of all documents are stored in the database server and all subsequent processing takes place on copies of the originals. The copy of the original document 2 is initially preprocessed and normalized at step 3, which entails processing the document 2 to ascertain whether it is in a preferred format and, if the document 2 is not in the preferred format, converting at least some of the information within the document 2 to the preferred format. The preferred format utilized in the preferred embodiment is UTF-8. The normalization step allows the preferred embodiment to take into account languages in addition to English and writing systems in addition to those based on Latin encoding. The modular software architecture of the preferred embodiment readily allows for the installation of additional or alternative language modules to enable the system to process documents 2 expressed in languages other than English and using character encoding other than Latin.

The normalisation step 3 also strips away the email header from the document. Copies of the preprocessed and normalized documents are stored in the document repository 4, which resides on the database server 54. After preprocessing and normalization the email document of the running example is as follows:

```
Hi Joe Alexander,
Thank you for inquiring about our Bank Services program.
Thank you for
your recent Bank Services inquiry. The Frank & Miller Bank
Services
program can give you one-stop convenience for all of your
upkeep and
home improvement needs, including online change of address
and utilities
connections with Speed Banking. Here is the link to access
this
information: http://bankservices.frankmiller.com. The
vendors are listed
by category and their contact information is also available
on-line. In
order to receive quotes on the services you've requested,
it is advised
to directly contact that vendor as Bank Services does not
have access to
pricing information.
If you require any moving services, however, please feel
free to browse
our website for our movers' information and then call us at
888.572.9427
so that we can set up an appointment for an estimate.
If you have any questions, please don't hesitate to email
or call at
888.572.9427.
Best Regards,
The Bank Services Team
888.572.9427
bankservices@frankmiller.com
-----Original Message-----
From: jalexanderhal@hotmail.com
[mailto: jalexanderhal@hotmail.com]
Sent: Monday, May 08, 2006 3:13 PM
To: Bank Services
Subject: Special Request
Frank & Miller Bank Services - Special Request
Submitted
    Time: 5/8/2006 4:12:32 PM
Origins
    Origin: Our Site
    Origin 2:
Message from
    Name: Joe Alexander Hal
    E-mail: jalexanderhal@hotmail.com
    Phone: (507) 359-7891
    Additional Phone:
    Contact Method: phone
    Contact Time: Evening (5:00 pm-8:00 pm)
    Contact ASAP: Yes
Customer responses
    I'm interested in buying a house, and I would like:
        More information on your Bank Services program
Frank & Miller - Your Favorite Bank Services Since 1875
```

The document is then parsed at step 5 so as to distinguish the text that was composed by the author from the non-author composed text.

The pre-processing, normalizing 3 and parsing 5 steps are described in detail in the applicant's co-pending Australian provisional patent application No. 2006906095, the contents of which are hereby incorporated in their entirety by way of reference. It will be appreciated that some of the document analysis steps to be described below with reference to the present invention are also carried out in some of the parsing analysis steps described in the above mentioned co-pending application. To assist with minimizing processing requirements, some embodiments of the present invention make use of at least some of the results of the parsing analysis rather than repeating the analysis in the steps to be described below.

Once the document has been parsed in step 5, the processor can distinguish between author composed text and non-author composed text. This allows the prediction of author traits to take place based primarily upon author composed text; thus avoiding the erroneous attribution of author traits based upon text that was not composed by the relevant author. In some embodiments the non-author composed text is deleted from the working copy of the document, whereas in the embodiment of the running example, the commencement of each section of author composed text is annotated with the tag <AuthorText> and the conclusion of each section of author composed text is annotated with the tag </Authortext>. Hence, further processing for author trait prediction focuses primarily upon the text that lies between these two tags.

The process flow of the computer 51 now progresses through several analysis steps, referred to as the text processing step 6, which includes an analysis of segmentation and punctuation, and the linguistic analysis step 7. Preferably the analysis steps are performed by software having modular architecture to facilitate changes to the types of analysis that may be performed, if required. The results of these analysis steps 6 and 7 are recorded in suitable memory or storage means accessible to the CPU of the computer 51. During segmentation analysis the text of email 2 is split into paragraphs, and the paragraphs are split into sentences. In the preferred embodiment this segmentation analysis is performed by a publicly available third party tool, known as the General Architecture for Text Engineering (GATE) segmentation tool, which is distributed by The University of Sheffield. Other third party segmentation tools, such those provided by Stanford University, may also be utilised.

Punctuation analysis takes place at step 7 of the process flow. In this step the computer 51 analyses the text at the character level so as to check for use of sentence punctuation marks and other predefined characters, such as:

special markers, e.g. two hyphens “--” (which often indicate that an email signature follows);

the greater-than character “>” (which often indicate the presence of reply lines);

quotation marks (which may signal the presence of a quotation);

emoticons (e.g. “:-)”, “:o)”) (which are typically indicative of either an emotive state of the author, or an emotive state that the author wishes to elicit from the recipient of the email).

The preferred embodiment records the results of the segmentation analysis and the punctuation analysis using annotations inserted in the text. As applied to the running example, this results in the following annotated email text:

```
<AuthorText><paragraph>Hi <Person>Joe
Alexander</Person>,</paragraph>
<paragraph><sentence>Thank you for inquiring about our
<Organization>Bank Services</Organization>
program.</sentence> <sentence>Thank you for your recent
<Organization>Bank Services</Organization>
inquiry.</sentence> <sentence>The <Organization>Frank &
Miller Bank Services</Organization> program can give you
one-stop convenience for all of your upkeep and home
improvement needs, including online change of address and
utilities connections with Speed Banking.</sentence>
<sentence>Here is the link to access this information:
<Url>http://bankservices.frankmiller.com</Url>.</sentence>
<sentence>The vendors are listed by category and their
contact information is also available on-line.</sentence>
<sentence>In order to receive quotes on the services you've
requested, it is advised to directly contact that vendor as
<Organization>Bank Services</Organization> does not have
access to pricing information.</sentence></paragraph>
<paragraph><sentence>If you require any moving services,
however, please feel free to browse our website for our
movers' information and then call us at
<Phone>888.572.9427</Phone> so that we can set up an
appointment for an estimate.</sentence></paragraph>
<paragraph><sentence>If you have any questions, please
don't hesitate to email or call at
<Phone>888.572.9427</Phone>.</sentence></paragraph>
<paragraph>Best Regards,
<signature>The <Organization>Bank Services</Organization>
Team
<Phone>888.572.9427</Phone>
<Email>bankservices@bw.com</Email></signature></paragraph><
/AuthorText>
<reply><paragraph>---Original Message---
From: <Email>jalexanderhal@hotmail.com</Email>
[mailto:<Email>jalexanderhal@hotmail.com</Email>]
Sent: <Date>Monday, May 08, 2006</Date> <Time>3:13
PM</Time>
To: <Organization>Bank Services</Organization>
Subject: Special Request</paragraph>
<paragraph><Organization>Frank & Miller Bank
Services</Organization> - Special request</paragraph>
<paragraph>Submitted
    Time: <Date>5/8/2006</Date> <Time>4:12:32
PM</Time></paragraph>
<paragraph>Origins
    Origin: Our Site
    Origin 2:</paragraph>
<paragraph>Message from
    Name: <Person>Joe Alexander Hal</Person>
    E-mail: <Email>jalexanderhal@hotmail.com</Email>
    Phone: <Phone>(507) 359-7891</Phone>
    Additional Phone:
    Contact Method: phone
    Contact Time: Evening (<Time>5:00 pm</Time> -
<Time>8:00 pm</Time>)
    Contact ASAP: Yes </paragraph>
<paragraph>Customer
responses
<sentence>I'm interested in renting, and I would
like:</sentence>
<sentence>More information on your <Organization>Bank
Services</Organization>
program</sentence></paragraph></reply>
<advert><paragraph><Organization>Frank &
Miller<Organization> - Your Favorite <Organization>Bank
Services</Organization> Provider Since
1875</paragraph></advert>
```

The linguistic analysis performed by the computer 51 at step 7 involves an analysis of the words in the text, including identification of predefined words and phrases of various types. An exemplary list of some of the types of words and phrases that are identified in this stage of the analysis is set out in table 1.

TABLE 1

| Word or Phrase Type | Examples |
|---|---|
| peoples' names | “James”, “Jane” |
| Locations | “Sydney”, “United Arab Emirates” |
| Dates | “23/10/2006”, “Monday the 23rd of June” |
| times | “noon”, “12:30 pm” |
| Organizations | “Microsoft”, “IBM” |
| Currency | “$20”, “£16” |
| uniform resource | “http://www.google.com” |
| locators (URL's) | |
| email addresses | “joe.blogg@domain.com” |
| Addresses | “29 High Street” |
| organizational descriptors | “Dept.”, “Division” |
| phone numbers | +61 2 9476 0477 |
| typical greetings | “Hi”, “Dear” |
| typical farewells | “Best regards”, “Cheers” |

The preferred embodiment has an extensive database of examples of such types of words and phrases, which functions as a lexicon to assist in the identification of such key words and phrases. This data is stored in database server 54. In the preferred embodiment the results of the linguistic analysis step 7 are inserted as annotations into the text in the manner described above. As applied to the running example, this results in the following annotated email text (for the sake of brevity, only the annotations associated with the text reading “Hi Joe Alexander” are set out below):

<?xml version=“1.0” ?>
<Document><text begin=“0” beginLine=“0” end=“999”
endLine=“21” nodeId=“mime:Body_2”><Sentence begin=“0”
end=“17” nodeId=“mime:Body_2”><Paragraph begin=“0” end=“17”
indent=“False” nodeId=“mime:Body_2”><Token begin=“0”
category=“NNP” end=“2” kind=“word” length=“2”
nodeId=“mime:Body_2” orth=“upperInitial”
startSentence=“true”>Hi</Token><SpaceToken begin=“2”
end=“3” kind=“space” length=“1” nodeId=“mime:Body_2”>
</SpaceToken><Person begin=“3” end=“16”
nodeId=“mime:Body_2” rule=“PersonGazNoTitle”><Token
begin=“3” category=“NNP” end=“6” kind=“word” length=“3”
nodeId=“mime:Body_2” orth=“upperInitial”
startSentence=“false”>Joe</Token><SpaceToken begin=“6”
end=“7” kind=“space” length=“1” nodeId=“mime:Body_2”>
</SpaceToken><Token begin=“7” category=“NNP” end=“16”
kind=“word” length=“9” nodeId=“mime:Body_2”
orth=“upperInitial”
startSentence=“false”>Alexander</Token></Person><Token
begin=“16” category=“,” end=“17” kind=“punctuation”
length=“1” nodeId=“mime:Body_2”
startSentence=“false”>,</Token></Paragraph></Sentence>

In the illustrated preferred embodiment the analysed email document 2, including any annotations that have been inserted, is saved into the memory of the computer 51 in a digitally accessible format in an annotation repository 8, which resides on the database server 54. It will be appreciated that many other means for recording the results of the segmentation, punctuation and linguistic analysis of the text in digitally accessible formats may be devised by those skilled in the art. For example, in one such embodiment, text that has been analysed and which falls into a specific category is copied into a memory location or bulk storage location that is exclusively reserved for the relevant category of text.

To summarise the results of the analysis that has occurred to this point a number of features are calculated at step 9. Typically, a feature is a descriptive statistic calculated from either or both of the raw text and the annotations. Some features express the ratio of frequencies of two different annotation types (e.g. the ratio of sentence annotations to paragraph annotations), or the presence or absence of an annotation type (e.g. signature). More particularly, the features can be generally divided into three groupings:
Character level features—which summarise the analysis of each individual character in the text of the email. Typically the results of the punctuation analysis step provide the majority of these features. Examples include:
   proportion of characters that are:
      alphabetic,
      numeric,
      white space,
      punctuation, and
      special symbols;
   proportion of words with less than four characters; and
   mean word length.
Lexical level features—which summarise the keywords and phrases, emoticons, multiword prepositional phrases, farewell expressions, greeting expressions, part-of-speech tags, etc. identified during the linguistic analysis step 7. Examples include:
   frequency and distribution of different parts of speech;
   word type-token ratio;
   frequency distribution of specific function words drawn from the keyword database; and
   frequency distribution of multiword prepositions; and proportion of words that are function words.
Structural level features—which typically refer to the annotations made regarding structural features of the text such as the presence of a signature block, reply status, attachments, headers, etc. Examples include information regarding:
   indentation of paragraphs;
   presence of farewells;
   document length in characters, words, lines, sentences and/or paragraphs; and
   mean paragraph length in lines, sentences and/or words.

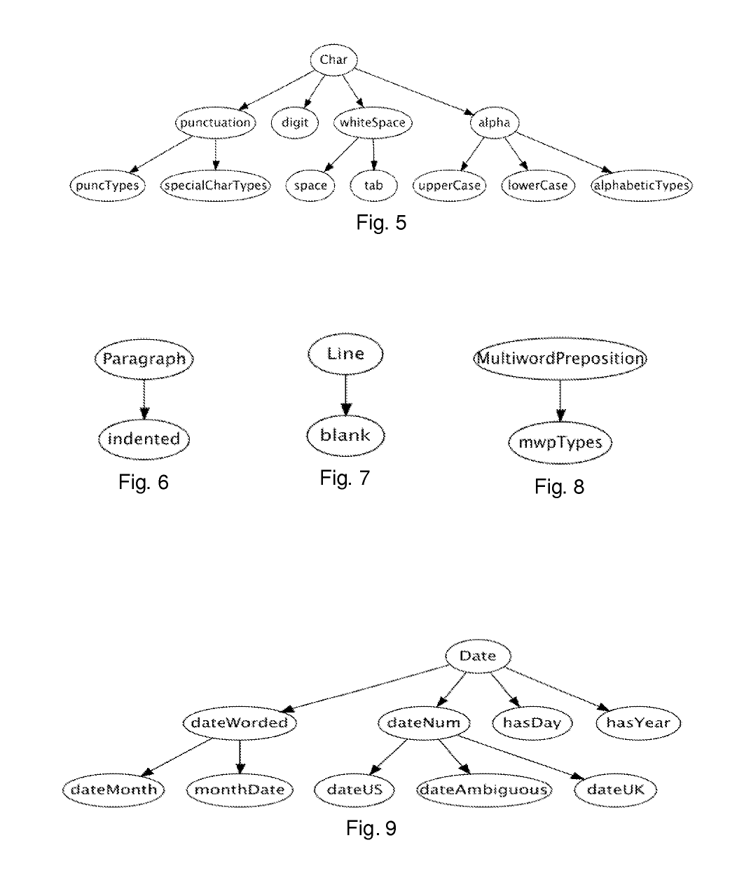

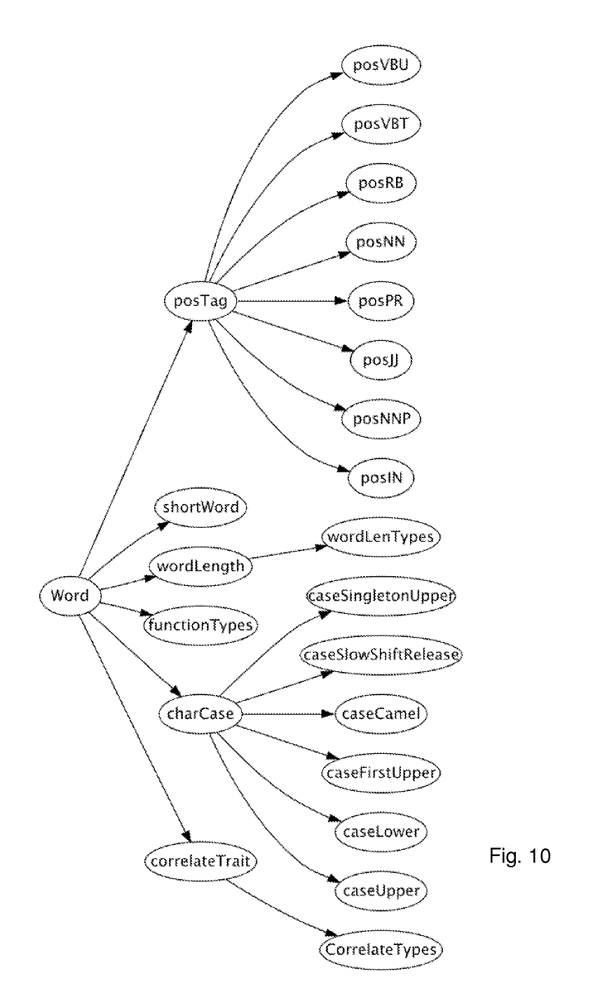

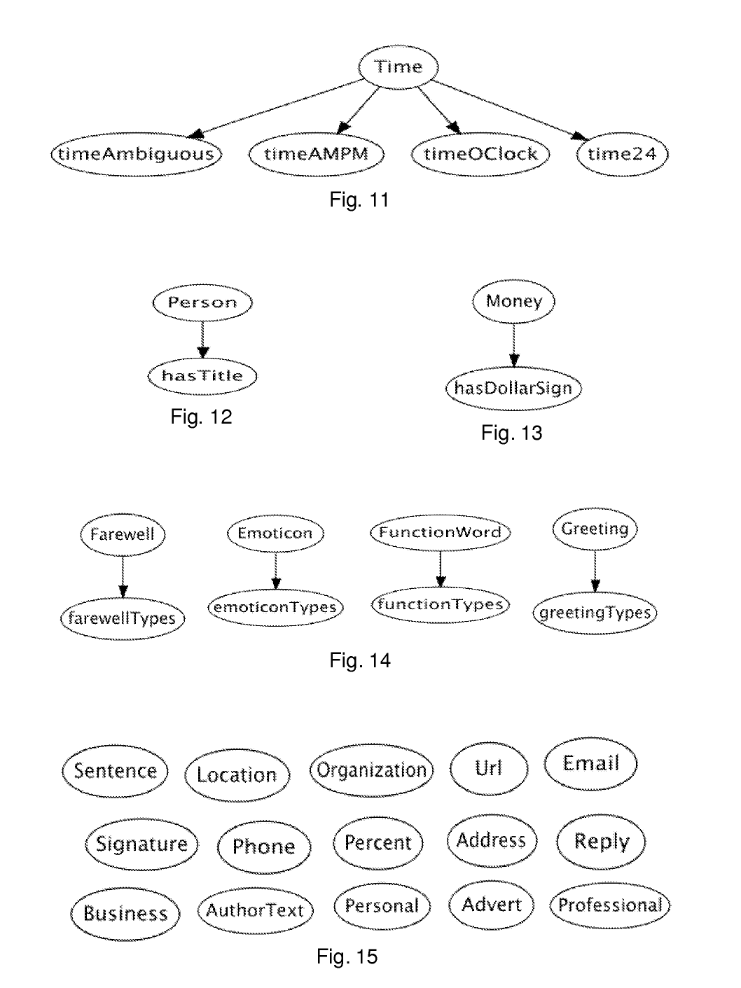

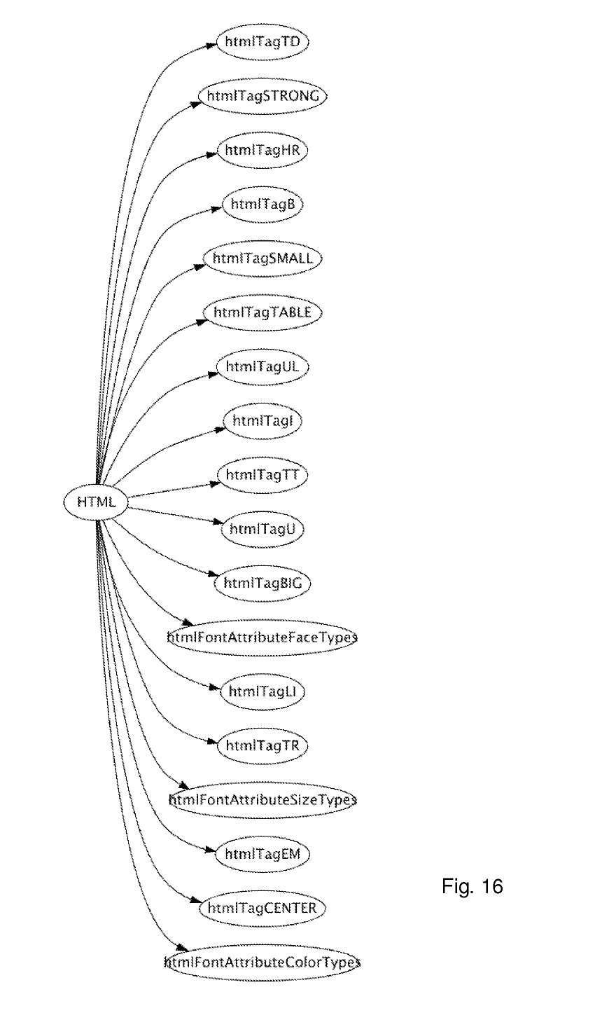

Information regarding the categories, descriptions and names of the various features that are calculated for a typical email document 2 in the preferred embodiment is set out in the following table. (Note: The ontologies of the character based features, word based features, paragraph based features, line based features, date based features, time based features, person based features, currency based features, lexicon based features and degenerate based features as used in the following list are shown in FIGS. 5 to 14 respectively.)

| | | |
|---|---|---|
| Feature Category | Feature Description | Feature Name |

CHARACTERS

| | | |
|---|---|---|
| | All chars | Char_count_all |
| | | Char_ratio_inWord_all |
| alpha | Alpha chars | Char_ratio_alpha_all |
| upperCase | Upper case chars | Char_ratio_upperCase_all |
| | | Char_ratio_upperCase_alpha |
| lowerCase | Lower case chars | |
| digit | Lower case chars | Char_ratio_digit_all |
| whiteSpace | White spaces | Char_ratio_space_whiteSpace |
| | | Char_ratio_whiteSpace_all |
| space | Spaces | Char_ratio_space_all |
| tab | Tabs | Char_count_tab |
| | | Char_ratio_tab_all |
| | | Char_ratio_tab_whiteSpace |
| punctuation | Punctuation | Char_count_punctuation |
| | | Char_ratio_punctuation_all |
| alphabeticA through alphabeticZ | character A, etc. | Char_count_alphabeticA, etc. |
| punc44 | punctuation character , | Char_count_punc44 |
| punc46 | punctuation character . | Char_count_punc46 |
| punc63 | punctuation character ? | Char_count_punc63 |
| punc33 | punctuation character ! | Char_count_punc33 |
| punc58 | punctuation character : | Char_count_punc58 |
| punc59 | punctuation character ; | Char_count_punc59 |
| punc39 | punctuation character ′ | Char_count_punc39 |
| punc34 | punctuation character ″ | Char_count_punc34 |
| specialChar126 | special character ~ | Char_count_specialChar126 |
| specialChar64 | special character @ | Char_count_specialChar64 |
| specialChar35 | special character # | Char_count_specialChar35 |
| specialChar36 | special character $ | Char_count_specialChar36 |
| specialChar37 | special character % | Char_count_specialChar37 |
| specialChar94 | special character | Char_count_specialChar94 |
| specialChar38 | special character & | Char_count_specialChar38 |
| specialChar42 | special character * | Char_count_specialChar42 |
| specialChar45 | special character - | Char_count_specialChar45 |
| specialChar95 | special character _{—} | Char_count_specialChar95 |
| specialChar61 | special character = | Char_count_specialChar61 |
| specialChar43 | special character + | Char_count_specialChar43 |
| specialChar60 | special character < | Char_count_specialChar60 |
| specialChar62 | special character > | Char_count_specialChar62 |
| specialChar91 | special character [ | Char_count_specialChar91 |
| specialChar93 | special character ] | Char_count_specialChar93 |
| specialChar123 | special character { | Char_count_specialChar123 |
| specialChar125 | special character } | Char_count_specialChar125 |
| specialChar92 | special character \ | Char_count_specialChar92 |
| specialChar47 | special character / | Char_count_specialChar47 |
| specialChar124 | special character \| | Char_count_specialChar124 |

WORDS

| | | |
|---|---|---|
| Word | All word Tokens | Word_count_all |
| | | Word_meanLengthIn_Char |
| | | Word_ratio_wordType_all |
| shortWord | Short words of length less than 4 | Word_ratio_shortWord_all |
| | characters | |
| functionWord | Function words from predefined | Word_ratio_functionWord_all |
| | lexicon such as: up, to | |
| wordLength | Intermediate entities consisting of | Word_ratio_wordLen1_all, etc. |
| | entities having various word lengths | |
| | 1-30 characters | |
| posTag | Intermediate entities consisting of | Word_ratio_posTag_all |
| | entities of various part-of-speech | |
| | types | |
| posNN | Words its part-of-speech equal NN | Word_ratio_posNN_all |
| posVBT | Words its part-of-speech equal VBT | Word_ratio_posVBT_all |
| posVBU | Words its part-of-speech equal VBU | Word_ratio_posVBU_all |
| posIN | Words its part-of-speech equal IN | Word_ratio_posIN_all |
| posJJ | Words its part-of-speech equal JJ | Word_ratio_posJJ_all |
| posRB | Words its part-of-speech equal RB | Word_ratio_posRB_all |
| posPR | Words its part-of-speech equal PR | Word_ratio_posPR_all |
| posNNP | Words its part-of-speech equal NNP | Word_ratio_posNNP_all |
| posPOS | Words its part-of-speech equal POS | Word_ratio_posPOS_all |
| posMD | Words its part-of-speech equal MD | Word_ratio_posMD_all |
| caseUpper | Words of character case type upper | Word_ratio_caseUpper_all |
| caseLower | Words of character case type lower | Word_ratio_caseLower_all |
| caseCamel | Words of character case type camel | Word_ratio_caseCamel_all |
| caseFirstUpper | Words of character case type | Word_ratio_caseFirstUpper_all |
| | firstUpper | |
| caseSlowShiftRelease | Words of character case type | Word_ratio_caseSlowShiftRelease_all |
| | slowShiftRelease | |
| caseSingletonUpper | Words of character case type | Word_ratio_caseSingletonUpper_all |
| | singletonUpper | |
| CorrelateEducated | Words correlating with author trait | Word_ratio_CorrelateEducated_all |
| | Educated | |
| CorrelateFemale | Words correlating with author trait | Word_ratio_CorrelateFemale_all |
| | Female | |
| CorrelateHighAgreeableness | Words correlating with author trait | Word_ratio_CorrelateHighAgreeableness_all |
| | HighAgreeableness | |
| CorrelateHighConscientiousness | Words correlating with author trait | Word_ratio_CorrelateHighConscientiousness_all |
| | HighConscientiousness | |
| CorrelateHighExtraversion | Words correlating with author trait | Word_ratio_CorrelateHighExtraversion_all |
| | HighExtraversion | |
| CorrelateHighNeuroticism | Words correlating with author trait | Word_ratio_CorrelateHighNeuroticism_all |
| | HighNeuroticism | |
| CorrelateHighOpenness | Words correlating with author trait | Word_ratio_CorrelateHighOpenness_all |
| | HighOpenness | |
| CorrelateLowAgreeableness | Words correlating with author trait | Word_ratio_CorrelateLowAgreeableness_all |
| | LowAgreeableness | |
| CorrelateLowConscientiousness | Words correlating with author trait | Word_ratio_CorrelateLowConscientiousness_all |
| | LowConscientiousness | |
| CorrelateLowExtraversion | Words correlating with author trait | Word_ratio_CorrelateLowExtraversion_all |
| | LowExtraversion | |
| CorrelateLowNeuroticism | Words correlating with author trait | Word_ratio_CorrelateLowNeuroticism_all |
| | LowNeuroticism | |
| CorrelateLowOpenness | Words correlating with author trait | Word_ratio_CorrelateLowOpenness_all |
| | LowOpenness | |
| CorrelateMale | Words correlating with author trait | Word_ratio_CorrelateMale_all |
| | Male | |
| CorrelateNonUS | Words correlating with author trait | Word_ratio_CorrelateNonUS_all |
| | NonUS | |
| CorrelateOld | Words correlating with author trait | Word_ratio_CorrelateOld_all |
| | Old | |
| CorrelateUneducated | Words correlating with author trait | Word_ratio_CorrelateUneducated_all |
| | Uneducated | |
| CorrelateUS | Words correlating with author trait | Word_ratio_CorrelateUS_all |
| | US | |
| CorrelateYoung | Words correlating with author trait | Word_ratio_CorrelateYoung_all |
| | Young | |
| Wordclasses | all wordclasses annotations | Word_ratio_wordClass_all |
| wordclassesSP | wordclass spelling error (SP) | Word_ratio_wordClassSP_all |
| wordclassesTP | wordclass typing error (TP) | Word_ratio_wordClassTP_all |
| wordclassesCF | wordclass creative wordformation | Word_ratio_wordClassCF_all |
| | (CF) | |
| wordclassesAB | wordclass abbreviation (AB) | Word_ratio_wordClassAB_all |
| wordclassesWS | wordclass missing whitespace (WS) | Word_ratio_wordClassWS_all |
| wordclassesGR | wordclass grammatical error (GR) | Word_ratio_wordClassGR_all |
| wordclassesFW | wordclass foreign word (FW) | Word_ratio_wordClassFW_all |

MULTIWORD PREPOSITIONS

| | | |
|---|---|---|
| MultiwordPrepositions | All multiword prepositions (mwp) | MultiwordPreposition_count_all |
| | | MultiwordPreposition_ratio_all_allWords |
| | | MultiwordPreposition_meanLengthIn_Word |
| | | MultiwordPreposition_meanLengthIn_Char |
| mwp0 through mwp19 | mwp's from predefined lexicon | MultiwordPreposition_ratio_mwp1_all |

FUNCTION WORDS

| | | |
|---|---|---|
| FunctionWord | All annotations of function words | FunctionWord_count_all |
| function0 through 149 | Annotations matching function | FunctionWord_ratio_function0_all, etc. |
| | word lexicon | |

GREETINGS

| | | |
|---|---|---|
| Greeting | All annotations of greeting words | Greeting_count_all |
| greeting0 through greeting86 | Annotations matching greeting | Greeting_count_greeting0, etc. |
| | lexicon | |

FAREWELLS

| | | |
|---|---|---|
| Farewell | All annotations of farewell words | Farewell_count_all |
| farewell0 through farewell186 | Annotations matching farewell | Farewell_count_farewell0, etc. |
| | lexicon | |

EMOTICONS

| | | |
|---|---|---|
| Emoticon | All annotations representing | Emoticon_count_all |
| | emoticon symbols | |
| emoticon0 through emoticon70 | Annotations matching emoticon | Emoticon_count_emoticon0, etc. |
| | lexicon | |

LINES

| | | |
|---|---|---|
| Line | All lines strings | Line_count_all |
| | | Line_meanLengthIn_Char |
| blank | Blank lines | Line_ratio_blank_all |

SENTENCES

| | | |
|---|---|---|
| Sentence | All sentence annotations | Sentence_count_all |
| | | Sentence_meanLengthIn_Char |
| | | Sentence_meanLengthIn_Word |

PARAGRAPHS

| | | |
|---|---|---|
| Paragraph | All paragraph annotations | Paragraph_count_all |
| | | Paragraph_meanLengthIn_Char |
| | | Paragraph_meanLengthIn_Word |
| | | Paragraph_meanLengthIn_Sentence |
| indented | Paragraphs with the first line | Paragraph_ratio_indented_all |
| | indented | |

HTML

| | | |
|---|---|---|
| html | HTML annotations, and annotations | HTML_count_all |
| | concerning the HTML | HTML_ratio_all_allWords |
| | | HTML_meanLengthIn_Char |
| | | HTML_meanLengthIn_Word |
| htmlTag | Intermediate entities consisting of | HTML_ratio_htmlTag_all |
| | entities of various HTML tags | |
| htmlFontAttributeSize1 through | HTML font tag with attribute | HTML_ratio_htmlFontAttributeSize1_htmlTag, etc. |
| Size7 | size = 1, etc. | |
| htmlFontAttributeSize −1 | HTML font tag with attribute | HTML_ratio_htmlFontAttributeSize−1_htmlTag |
| | size = −1 | |
| htmlFontAttributeSize +1 | HTML font tag with attribute | HTML_ratio_htmlFontAttributeSize+1_htmlTag |
| | size = +1 | |
| htmlFontAttributeSize −2 | HTML font tag with attribute | HTML_ratio_htmlFontAttributeSize−2_htmlTag |
| | size = −2 | |
| htmlFontAttributeColorNavy | HTML font tag with attribute | HTML_ratio_htmlFontAttributeColorNavy_htmlTag |
| | color = navy | |
| htmlFontAttributeColorTeal | HTML font tag with attribute | HTML_ratio_htmlFontAttributeColorTeal_htmlTag |
| | color = teal | |
| htmlFontAttributeColorLime | HTML font tag with attribute | HTML_ratio_htmlFontAttributeColorLime_htmlTag |
| | color = lime | |
| htmlFontAttributeColorGreen | HTML font tag with attribute | HTML_ratio_htmlFontAttributeColorGreen_htmlTag |
| | color = green | |
| htmlFontAttributeColorSilver | HTML font tag with attribute | HTML_ratio_htmlFontAttributeColorSilver_htmlTag |
| | color = silver | |
| htmlFontAttributeColorFuchsia | HTML font tag with attribute | HTML_ratio_htmlFontAttributeColorFuchsia_htmlTag |
| | color = fuchsia | |
| htmlFontAttributeColorWhite | HTML font tag with attribute | HTML_ratio_htmlFontAttributeColorWhite_htmlTag |
| | color = white | |
| htmlFontAttributeColorYellow | HTML font tag with attribute | HTML_ratio_htmlFontAttributeColorYellow_htmlTag |
| | color = yellow | |
| htmlFontAttributeColorBlack | HTML font tag with attribute | HTML_ratio_htmlFontAttributeColorBlack_htmlTag |
| | color = black | |
| htmlFontAttributeColorPurple | HTML font tag with attribute | HTML_ratio_htmlFontAttributeColorPurple_htmlTag |
| | color = purple | |
| htmlFontAttributeColorOlive | HTML font tag with attribute | HTML_ratio_htmlFontAttributeColorOlive_htmlTag |
| | color = olive | |
| htmlFontAttributeColorRed | HTML font tag with attribute | HTML_ratio_htmlFontAttributeColorRed_htmlTag |
| | color = red | |
| htmlFontAttributeColorMaroon | HTML font tag with attribute | HTML_ratio_htmlFontAttributeColorMaroon_htmlTag |
| | color = maroon | |
| htmlFontAttributeColorAqua | HTML font tag with attribute | HTML_ratio_htmlFontAttributeColorAqua_htmlTag |
| | color = aqua | |
| htmlFontAttributeColorGray | HTML font tag with attribute | HTML_ratio_htmlFontAttributeColorGray_htmlTag |
| | color = gray | |
| htmlFontAttributeColorBlue | HTML font tag with attribute | HTML_ratio_htmlFontAttributeColorBlue_htmlTag |
| | color = blue | |
| htmlFontAttributeColorOther | HTML font tag with attribute | HTML_ratio_htmlFontAttributeColorOther_htmlTag |
| | color = other | |
| htmlFontAttributeFaceArial | HTML font tag with attribute | HTML_ratio_htmlFontAttributeFaceArial_htmlTag |
| | face = arial | |
| htmlFontAttributeFaceVerdana | HTML font tag with attribute | HTML_ratio_htmlFontAttributeFaceVerdana_htmlTag |
| | face = verdana | |
| htmlFontAttributeFaceTahoma | HTML font tag with attribute | HTML_ratio_htmlFontAttributeFaceTahoma_htmlTag |
| | face = tahoma | |
| htmlFontAttributeFaceGaramond | HTML font tag with attribute | HTML_ratio_htmlFontAttributeFaceGaramond_htmlTag |
| | face = garamond | |
| htmlFontAttributeFaceGeorgia | HTML font tag with attribute | HTML_ratio_htmlFontAttributeFaceGeorgia_htmlTag |
| | face = georgia | |
| htmlFontAttributeFaceWingdings | HTML font tag with attribute | HTML_ratio_htmlFontAttributeFaceWingdings_htmlTag |
| | face = wingdings | |
| htmlFontAttributeFacePapyrus | HTML font tag with attribute | HTML_ratio_htmlFontAttributeFacePapyrus_htmlTag |
| | face = papyrus | |
| htmlFontAttributeFaceDefault | HTML font tag with attribute | HTML_ratio_htmlFontAttributeFaceDefault_htmlTag |
| | face = default | |
| htmlTagB | HTML <B> tags | HTML_ratio_htmlTagB_htmlTag |
| htmlTagI | HTML <I> tags | HTML_ratio_htmlTagI_htmlTag |
| htmlTagSTRONG | HTML <STRONG> tags | HTML_ratio_htmlTagSTRONG_htmlTag |
| htmlTagU | HTML <U> tags | HTML_ratio_htmlTagU_htmlTag |
| htmlTagTT | HTML <TT> tags | HTML_ratio_htmlTagTT_htmlTag |
| htmlTagSMALL | HTML <SMALL> tags | HTML_ratio_htmlTagSMALL_htmlTag |
| htmlTagBIG | HTML <BIG> tags | HTML_ratio_htmlTagBIG_htmlTag |
| htmlTagEM | HTML <EM> tags | HTML_ratio_htmlTagEM_htmlTag |
| htmlTagTABLE | HTML <TABLE> tags | HTML_ratio_htmlTagTABLE_htmlTag |
| htmlTagTR | HTML <TR> tags | HTML_ratio_htmlTagTR_htmlTag |
| htmlTagTD | HTML <TD> tags | HTML_ratio_htmlTagTD_htmlTag |
| htmlTagHR | HTML <HR> tags | HTML_ratio_htmlTagHR_htmlTag |
| htmlTagCENTER | HTML <CENTER> tags | HTML_ratio_htmlTagCENTER_htmlTag |
| htmlTagLI | HTML <LI> tags | HTML_ratio_htmlTagLI_htmlTag |
| htmlTagUL | HTML <UL> tags | HTML_ratio_htmlTagUL_htmlTag |

AUTHOR_TEXT

| | | |
|---|---|---|
| AuthorText | All author text annotations | AuthorText_count_all |

REPLY

| | | |
|---|---|---|
| Reply | All reply annotations | Reply_count_all |

SIGNATURE

| | | |
|---|---|---|
| Signature | All signature annotations | Signature_count_all |

PERSONAL

| | | |
|---|---|---|
| personal | all category personal annotations | personal_count_all |

PROFESSIONAL

| | | |
|---|---|---|
| professional | all category professional | professional_count_all |
| | annotations | |

BUSINESS

| | | |
|---|---|---|
| business | all category business annotations | business_count_all |

TIME

| | | |
|---|---|---|
| Time | All Time annotations | Time_count_all |
| | | Time_ratio_all_allWords |
| | | Time_meanLengthIn_Char |
| | | Time_meanLengthIn_Word |
| time24 | Time annotations such as 23:15 or | Time_ratio_time24_all |
| | 08:15 | |
| timeAMPM | Time annotations having am or pm | Time_ratio_timeAMPM_all |
| | tokens e.g. 8:15 am | |
| timeOClock | Time annotations such as 5 o'clock | Time_ratio_timeOClock_all |
| timeAmbiguous | Time annotations that are | Time_ratio_timeAmbiguous_all |
| | ambiguous e.g. 8:15 | |

MONEY

| | | |
|---|---|---|
| Money | All Money annotations | Money_count_all |
| | | Money_ratio_all_allWords |
| | | Money_meanLengthIn_Char |
| | | Money_meanLengthIn_Word |
| hasDollarSign | Money annotations having a dollar | Money_ratio_hasDollarSign_all |
| | sign e.g. $5.0 | |

PERSON

| | | |
|---|---|---|
| Person | All Person annotations | Person_count_all |
| | | Person_ratio_all_allWords |
| | | Person_meanLengthIn_Char |
| | | Person_meanLengthIn_Word |
| hasTitle | Person annotations having a title | Person_ratio_hasTitle_all |
| | e.g. Mr. John Smith | |

DATE

| | | |
|---|---|---|
| Date | All Date annotations | Date_count_all |
| | | Date_ratio_all_allWords |
| | | Date_meanLengthIn_Char |
| | | Date_meanLengthIn_Word |
| dateNum | Date annotations with numeric | Date_ratio_dateNum_all |
| | month component | |
| dateWorded | Date annotations with worded | Date_ratio_dateWorded_all |
| | month component | |
| hasDay | Date annotations with a day | Date_ratio_hasDay_all |
| | specified | |
| hasYear | Date annotations with a year | Date_ratio_hasYear_all |
| | specified | |
| dateUK | Numeric Date annotations written | Date_ratio_dateUK_dateNum |
| | in UK format e.g. 30/12/2005 | |
| dateUS | Numeric Date annotations written | Date_ratio_dateUS_dateNum |
| | in US format e.g. 12/30/2005 | |
| dateAmbiguous | Numeric Date annotations with | Date_ratio_dateAmbiguous_dateNum |
| | ambiguous(US or UK) style e.g. | |
| | 5/6/2005 | |
| monthDate | Worded Date annotations with | Date_ratio_monthDate_dateWorded |
| | month before date e.g. July 7th | |
| dateMonth | Worded Date annotations with date | Date_ratio_dateMonth_dateWorded |
| | before month e.g. 7th of July | |

ADDRESS

| | | |
|---|---|---|
| Address | all address annotations | Address_count_all |
| | | Address_meanLengthIn_Char |
| | | Address_meanLengthIn_Word |
| | | Address_ratio_all_allWords |

EMAIL

| | | |
|---|---|---|
| Email | all email annotations | Email_count_all |
| | | Email_meanLengthIn_Char |
| | | Email_meanLengthIn_Word |
| | | Email_ratio_all_allWords |

LOCATION

| | | |
|---|---|---|
| Location | all location annotations | Location_count_all |
| | | Location_meanLengthIn_Char |
| | | Location_meanLengthIn_Word |
| | | Location_ratio_all_allWords |

ORGANIZATION

| | | |
|---|---|---|
| Organization | all organization annotations | Organization_count_all |
| | | Organization_meanLengthIn_Char |
| | | Organization_meanLengthIn_Word |
| | | Organization_ratio_all_allWords |

PERCENT

| | | |
|---|---|---|
| Percent | all percent annotations | Percent_count_all |
| | | Percent_meanLengthIn_Char |
| | | Percent_meanLengthIn_Word |
| | | Percent_ratio_all_allWords |

PHONE

| | | |
|---|---|---|
| Phone | all phone annotations | Phone_count_all |
| | | Phone_meanLengthIn_Char |
| | | Phone_meanLengthIn_Word |
| | | Phone_ratio_all_allWords |

URL

| | | |
|---|---|---|
| Url | all url annotations | Url_count_all |
| | | Url_meanLengthIn_Char |
| | | Url_meanLengthIn_Word |
| | | Url_ratio_all_allWords |

It will be appreciated by those skilled in the art that in the above feature list “char” is short for “character” and the numbers after the terms “punc” and “specialChar” refer to the American Standard Code for Information Interchange (ASCII). Hence, for example, the feature Char_count_punc33 is a numeric value equal to the number of times ASCII code 33 (i.e. !) is used in the document being analysed. Some of the other features mentioned in the above list are counts and/or ratios associated with user-defined lexicons of commonly used emoticons, farewells, function words, greetings and multiword prepositions. Each of the feature names is a variable that is set to a numeric value that is calculated for the respective feature. For example, for an email comprised of 488 characters, the variable char_count_all is set to a value of 488.

These features are converted into a data structure associated with the document. The type of data structure chosen must be compatible for use with the type of machine learning system that will be used in step 12. The preferred embodiment uses feature vectors as the preferred data structure and makes use of the Support Vector Machines technique in the machine learning system. A feature vector is essentially a list of features that is structured in a predefined manner to function as input for the Support Vector Machines processing that occurs at step 12. With reference to the running example, the feature vector is as follows:

11:0.227272727273 12:16.0 13:4.925 14:0.6625 15:0.425
16:0.4 17:0.788788788789 18:0.784784784785
19:0.029029029029 20:0.02002002002 21:0.164164164164
22:0.142142142142 23:0.865853658537 26:0.031031031031
28:0.18125 29:0.21875 30:0.16875 31:0.05625 32:0.09375
33:0.1 34:0.075 35:0.04375 37:0.05625 38:0.00625 57:1 58:2
59:1 60:999 62:56 63:9 64:35 65:21 66:106 67:15 68:10 69:29
70:63 72:5 73:21 74:22 75:61 76:72 77:13 78:7 79:58 80:52
81:61 82:24 83:22 84:7 86:14 87:1 94:1 96:2 107:2 109:160
110:98.3 111:7 112:14 115:2 117:3 120:0.0147058823529
123:0.0147058823529 127:0.0294117647059 128:0.0588235294118
130:0.0294117647059 134:0.0147058823529 136:0.0147058823529
137:0.0294117647059 147:0.0147058823529 148:0.0294117647059
150:0.0147058823529 161:0.0735294117647 163:0.0294117647059
168:0.0294117647059 169:0.0147058823529 170:0.0147058823529
173:0.0441176470588 174:0.0147058823529 196:0.0294117647059
198:0.0147058823529 203:0.0147058823529 204:0.0441176470588
218:0.0147058823529 225:0.0294117647059 226:0.0735294117647
227:0.0147058823529 231:0.0147058823529 236:0.0882352941176
243:0.0147058823529 245:0.0147058823529 248:0.0147058823529
261:0.0147058823529 267:0.0882352941176 268:0.0294117647059
269:22 270:10 271:5 272:2.0 273:199.8 274:32.0 276:0.2375
277:0.09375 278:0.11875 279:0.0375 280:0.04375 281:0.11875
282:0.06875 283:0.11875 368:3 371:5 372:1 374:2 379:0.01875
382:0.03125 383:0.00625 385:0.0125 390:10.3333333333
393:15.2 394:36.0 396:12.0 401:1.66666666667 404:2.4
405:4.0

For brevity, any features with a nil value have been omitted from the above list. It can be seen that the first feature in this list is coded as feature 11, and has 0.227272727273 as its value.

In addition to, or as an alternative to, the Support Vector Machines technique, various other preferred embodiments make use of one or more of the following types of known machine learning techniques, including:

Nave Bays;

Decision Trees;

Lazy Learners;

Rule-based Learners;

Ensemble/meta-learners and/or

Maximum Entropy.

The classifier 11 is a function defining a logical correlation between input feature vectors and a specific predicted author trait. At step 12 the machine learning system, using the Support Vector Machines technique, receives the feature vector as input and the classifier 11 selects the most relevant features to use in the prediction of the trait for which the classifier 11 has been trained. In other words, the classifier 11 is responsive to the feature vector so as to predict likely traits 13 associated with the author of the document. The specific function implemented by the classifier 11 for any given author trait is established during a training phase, which is conducted prior to use of the machine learning system in the operational mode that has been described thus far.

The author traits that are predicted by the preferred embodiment include the following six demographic traits: age; gender; educational level; native language; country of origin and geographic region. Additionally, the preferred embodiment predicts the following psychometric traits: extraversion; agreeableness; conscientiousness; neuroticism; and openness. It will be appreciated that other preferred embodiments provide a greater or lesser number of predicted author traits as their output. In particular, some embodiments output at least three of the six demographic traits and at least three of the following six psychometric traits:

extraversion; agreeableness; conscientiousness; neuroticism; psychoticism and openness.

The output is initially in a coded format, which for the running example looks as follows:

0:u23-938484 1:3.0 2:2.0 3:1.0 4:2.0 5:3.0 6:1.0 7:4.0
8:1.0 9:2.0 10:1.0

In the above coded output list, the first trait, which is represented by code “0” is the predicted identity, which has a value of “u23-938484”. The second predicted trait, which is represented by code “1”, relates to the authors predicted openness and it has a value of “3.0” on a scale of 1 to 5. Other predicted traits and their associated codes are as follows:

| Predicted Author Trait | Associated Code |
|---|---|
| Conscientiousness | 2 |
| Agreeableness | 3 |
| Neuroticism | 4 |
| Extraversion | 5 |
| Educational level | 6 |
| Geographic Region | 7 |
| Country of Origin | 8 |
| Gender | 9 |
| Age as at 1 Jan. 2006 | 10 |

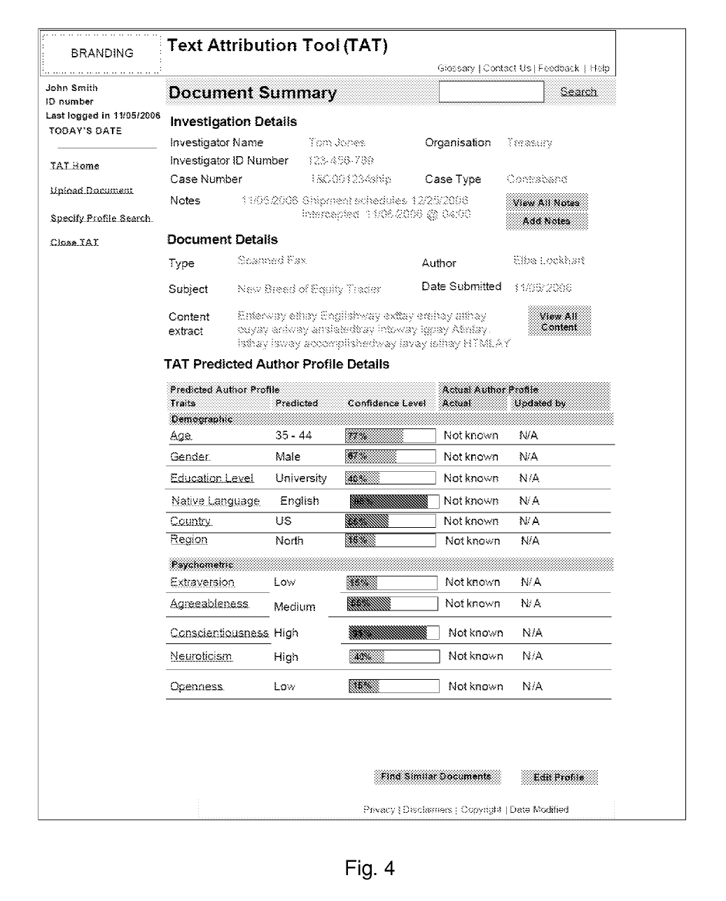

The coded output is processed by the computer 51 and displayed in a user-friendly display format on the screen 58 of the laptop computer 56. A random example of such a display format is shown in the screen grab illustrated in FIG. 4. Each of the predicted author traits is associated with a confidence level representing an estimate of the likelihood that the predicted trait is correct. For example, it can be seen from FIG. 4 that the predicted age of the author is 35-44, and this prediction is associated with a confidence level of 77%. The confidence levels for any given author trait are calculated by the machine learning system based upon the strength of correlation between the selected input features and the relevant predicted author trait.

A method of training the machine learning system is depicted in FIG. 2. This method includes compiling a representative sample of training documents 14, each of which were authored by known authors. Each of the training documents 14 are associated with known author trait information, which is compiled by subjecting the known authors to a questionnaire having questions adapted to elicit answers relating to their demographic and/or psychometric traits. For the determination of psychometric traits, the preferred embodiment makes use of the IPIP (International Personality Item Protocol) questionnaire for authors that compose text in English. Other embodiments make use of the Eysenck Personality Questionaire, for example. The known author trait information is stored in the trait repository 19, which is located on the database server 54. The training documents 14 are normalized in the manner described earlier and saved in the training document repository 15. The training method also includes a checking step 16 in which the normalized training documents are checked to filter out any erroneous content and to ensure consistency and accuracy of the training data. This checking is typically performed manually.

During training, classifiers are created by the selection of sets of features for each author trait. For each experiment, ten-fold cross-validation is preferably used. Ten-fold cross validation refers to the practice of using a 90-10 split of the data for experiments and repeating this process for each 90-10 split of the data. To guarantee a reasonably random split of the data, the splits are randomized but must be reproducible. To evaluate and test the classifiers, new documents are given as input and existing classifiers are selected to predict author traits. Another option is to keep 10% of the data for testing purposes while 90% is used for training and tuning. The training and tuning data is split into 90% for training and 10% for tuning. This process gets repeated for each 90-10 split of the training/tuning data, in a 10-fold cross-validation. As previously mentioned, to guarantee a reasonably random split of the data in the 10-fold cross-validation process, the training/tuning splits are randomized, but the splits are reproducible.

The further analysis, and feature vector formation steps in training mode take place in the same manner as previously described for the operational mode. However, in the training mode matched pairs of feature vectors and author traits are processed at step 18 using known machine learning techniques so as to formulate a function, which is also referred to as a classifier 17 that is a predictive model for each required author trait. This process may entail a number of iterations before a suitable level of predictive accuracy is achieved. The classifiers 17 that are created from this training process are subsequently used as the classifiers 11 in the operational mode. Typically, each classifier 11 or 17 is not only specific to a particular author trait, but is also specific to a particular document type, such as emails, extracts from chat room communications, etc.

It will be appreciated by those skilled in the art that the present invention may be embodied in computer software in the form of executable code for instructing a computer to perform the inventive method. The software and its associated data are capable of being stored upon a computer-readable medium in the form of one or more compact disks (CD's). Alternative embodiments make use of other forms of digital storage media, such as Digital Versatile Discs (DVD's), hard drives, flash memory, Erasable Programmable Read-Only Memory (EPROM), and the like. Alternatively the software and its associated data may be stored as one or more downloadable or remotely executable files that are accessible via a computer communications network such as the internet.

Hence, the processing of documents undertaken by the preferred embodiment advantageously predicts a number of author traits. If properly configured and trained, preferred embodiments of the invention perform the predictions with a comparatively high degree of accuracy. Additionally, the preferred embodiment is not confined to analysis of the text of a small number of different authors, which compares favourably with at least some of the known prior art. The predictive processing is achieved with the use of a rich set of linguistic features, such as a database storing a plurality of named entities, common greetings and farewell phrases. The predictive processing also makes use of a comprehensive set of punctuation features. Additionally, the use of segmentation analysis provides further useful input to the predictive processing. The preferred embodiment is advantageously configurably to function with input documents from a variety of sources. Advantageously, the preferred embodiments is also configurable to process documents expressed in languages other than English. Provided the machine learning system is regularly re-trained on a contemporary set of training data, the preferred embodiment can also effectively keep abreast of newly emergent writing styles and expressions. This assists in maintaining a comparatively high degree of accuracy as writing genres evolve over time.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

1. A computer implemented method of processing a digitally encoded document having text composed by an author, said method including the steps of:
using a processor to analyse segmentation of the text and storing results of said segmentation analysis in a digitally accessible format;
using a processor to analyse punctuation of the text and storing results of said punctuation analysis in a digitally accessible format;
using a processor to linguistically analyse the text and storing results of said linguistic analysis in a digitally accessible format; and
predicting an author trait using a machine learning system that is adapted to receive the results of said linguistic analysis, said segmentation analysis and said punctuation analysis as input, said machine learning system having been trained to process said input so as to output at least one predicted author trait, wherein said at least one predicted author trait is a demographic trait.

2. A method according to claim 1 wherein said linguistic analysis includes identification of predefined words and phrases in the text.

3. A method according to claim 2 wherein said words and phrases include any one or more of the following types:
peoples' names, locations, dates, times, organizations, currency, uniform resource locators (URL's), email addresses, addresses, organizational descriptors, phone numbers, typical greetings and/or typical farewells.

4. A method according to claim 3 further including the use of a database of words and phrases of any one or more of the following types:
peoples' names, locations, dates, times, organizations, currency, uniform resource locators (URL's), email addresses, addresses, organizational descriptors, phone numbers, typical greetings and/or typical farewells.

5. A method according to claim 1 wherein the segmentation analysis includes an analysis of the paragraph segmentation used in the text.

6. A method according to claim 1 wherein the segmentation analysis includes an analysis of the sentence segmentation used in the text.

7. A method according to claim 1 wherein the results of said linguistic analysis, said segmentation analysis and said punctuation analysis are represented by one or more data structures associated with the document.

8. A method according to claim 7 wherein the data structures are feature vectors.

9. A method according to claim 1 wherein the machine learning system utilizes any one or more of the following techniques:
Support Vector Machines;
Naïve Bayes;
Decision Trees;
Lazy Learners;
Rule-based Learners;
Ensemble/meta-learners and/or
Maximum Entropy.

10. A method according to claim 1 wherein the machine learning system has been trained with reference to a representative sample of training documents and with reference to known author trait information associated with each of the training documents.

11. A method according to claim 1 including a step of processing the document to ascertain whether the document is in a preferred format and, if the document is not in the preferred format, converting at least some of the information within the document to the preferred format.

12. A method according to claim 1 wherein the document is, or includes, any one of:
an email; text sourced from an email; data sourced from a digital source; text sourced from an online newsgroup discussion; text sourced from a multiuser online chat session; a digitized facsimile; an SMS message; text sourced from an instant messaging communication session; a scanned document; text sourced by means of optical character recognition; text sourced from a file attached to an email; text sourced from a digital file; a word processor created file; a text file; or text sourced from a web site.

13. A method according to claim 1 wherein said demographic trait includes any one or more of:
age; gender; educational level; native language; country of origin and/or geographic region.

14. A computer implemented method of processing a digitally encoded document having text composed by an author, said method including the steps of:
using a processor to analyse segmentation of the text and storing results of said segmentation analysis in a digitally accessible format;
using a processor to analyse punctuation of the text and storing results of said punctuation analysis in a digitally accessible format;
using a processor to linguistically analyse the text and storing results of said linguistic analysis in a digitally accessible format; and
predicting an author trait using a machine learning system that is adapted to receive the results of said linguistic analysis, said segmentation analysis and said punctuation analysis as input, said machine learning system having been trained to process said input so as to output at least one predicted author trait, wherein said at least one predicted author trait is a psychometric trait.

15. A method according to claim 14 wherein said psychometric trait includes any one or more of:
extraversion; agreeableness; conscientiousness; neuroticism; psychoticism and/or openness.

16. A method according to claim 14 wherein said at least one predicted author trait is associated with a confidence level representing an estimate of the likelihood that the predicted trait is correct.

17. A method according to claim 14 wherein the document is parsed so as to distinguish author composed text from non-author composed text and wherein only author composed text is primarily used as the basis for the prediction of author traits.

18. A method of training a machine learning system, said method including:
compiling a representative sample of training documents, each training document being associated with known author trait information;
using a processor to linguistically analyse text of the training documents and storing the results of said linguistic analysis in a digitally accessible format;
using a processor to analyse segmentation of the text of the training documents and storing the results of said segmentation analysis in a digitally accessible format;
using a processor to analyse punctuation of the text of the training documents and storing the results of said punctuation analysis in a digitally accessible format; and
using the machine learning system in a training mode to process the results of said linguistic analysis, said segmentation analysis and said punctuation analysis, along with the associated known author trait information, so as to formulate a function for use by the machine learning system in an operational mode to process input documents so as to output at least one predicted author trait, wherein said at least one predicted author trait is a demographic trait and/or a psychometric trait.

19. A method according to claim 18 wherein at least some of said known author trait information is compiled by subjecting known authors to a questionnaire.

20. A method according to claim 19 wherein said questionnaire includes questions adapted to elicit answers relating to demographic and/or psychometric traits of the known authors.

21. The method according to claim 1 where the steps are implemented using a computer-readable medium containing computer executable code for instructing a computer.

22. The method according to claim 1 where the steps are implemented using a downloadable or remotely executable file or combination of files containing computer executable code for instructing a computer.

23. The method according to claim 1 where the steps are implemented using a computing apparatus having a central processing unit, associated memory and storage devices, and input and output devices.

24. A machine learning system for processing a digitally encoded document having text composed by an author, said machine learning system having been trained to process said document so as to output at least three of the following six predicted author traits:
age; gender; educational level; native language; country of origin and/or geographic region.

25. A machine learning system for processing a digitally encoded document having text composed by an author, said machine learning system having been trained to process said document so as to output at least three of the following six predicted author traits:
extraversion; agreeableness; conscientiousness; neuroticism; psychoticism and/or openness.
